(19) United States
(12) Patent Application Publication
(10) Pub. No.: US 2014/0377674 A1
(43) Pub. Date: Dec. 25, 2014

(54) FUEL CELL AIR FLOW METHOD AND SYSTEM

(71) Applicant: NUVERA FUEL CELLS, INC., Billerica, MA (US)

(72) Inventor: Mattia DANESE, Milano (IT)

(73) Assignee: NUVERA FUEL CELLS, INC.

(21) Appl. No.: 14/311,912

(22) Filed: Jun. 23, 2014

Related U.S. Application Data
(60) Provisional application No. 61/838,743, filed on Jun. 24, 2013.

(51) Int. Cl. H01M 8/04

(52) U.S. Cl. CPC H01M 8/04126
USPC 429/413

(57) ABSTRACT

A method of managing air flow for a fuel cell power system comprising, providing air expelled from a compressor and providing air expelled from a humidification device. The method further includes mixing the air expelled from the compressor with the air expelled from the humidification device upstream of a fuel cell and supplying the mixture to a cathode of the fuel cell.

The present disclosure is directed towards air flow management for fuel cells, and more particularly, air flow management of fuel cells used in power systems.

A fuel cell is a device used for generating electric current from chemical reactions. Fuel cell technology offers a promising alternative to traditional power sources for a range of technologies, for example, transportation vehicles and portable power supply applications. A fuel cell converts the chemical energy of a fuel (e.g., hydrogen, natural gas, methanol, gasoline, etc.) into electricity through a chemical reaction with oxygen or other oxidizing agents. The chemical reaction typically yields electricity, heat, and water. A basic fuel cell comprises a negatively charged anode, a positively charged cathode, and an ion-conducting material called an electrolyte.

Different fuel cell technologies utilize different electrolyte materials. A Proton Exchange Membrane (PEM) fuel cell, for example, utilizes a polymeric ion-conducting membrane as the electrolyte. In a hydrogen PEM fuel cell, hydrogen atoms are electrochemically split into electrons and protons (hydrogen ions) at the anode. The electrochemical reaction at the anode is 2H₂→4H⁺+4e⁻.

The electrons produced by the reaction flow through an electric load circuit to the cathode, producing direct-current electricity. The protons produced by the reaction diffuse through the electrolyte membrane to the cathode. An electrolyte can be configured to prevent the passage of negatively charged electrons while allowing the passage of positively charged ions.

Following passage of the protons through the electrolyte, the protons can react at the cathode with electrons that have passed through the electric load circuit.

The electrochemical reaction at the cathode produces water and heat, as represented by the exothermic reaction: O₂+4H⁺+4e⁻→2H₂O.

In operation, a single fuel cell can generally generate about 1 volt. To obtain the desired amount of electrical power for a particular application, individual fuel cells are combined to form a fuel cell stack. The fuel cells are stacked together sequentially, each cell including a cathode, an electrolyte membrane, and an anode. Each cathode/membrane/anode assembly constitutes a “membrane electrode assembly” (MEA), which is typically supported on both sides by bipolar plates. Gases (hydrogen and air) are supplied to the electrodes of the MEA through channels or grooves formed in the plates, which are known as flow fields. In addition to providing mechanical support, the bipolar plates (also known as flow field plates or separator plates) physically separate individual cells in a stack while electrically connecting them. The bipolar plates also act as current collectors, provide access channels for the fuel and the oxidant to the respective electrode surfaces, and provide channels for the removal of water formed during operation of the fuel cell. The water formed from the cathode reaction must be continuously removed from the cathode to facilitate additional reaction. The water can be removed from the cathode in the form of exhaust gas moisture.

In a proton exchange membrane (PEM) fuel cell, the polymeric ion-conducting membrane acting as the electrolyte requires a certain level of humidity to facilitate conductivity of the membrane. A major challenge for optimum fuel cell performance is maintaining proper membrane humidity of the PEM fuel cell. A PEM membrane that is less than fully hydrated can cause a decrease in protonic conductivity and may result in resistive loss, decreased power output, and decreased membrane life. On the other hand, the presence of too much water in the membrane may flood the membrane, potentially blocking flow channels through the membrane and negatively affecting fuel cell performance and operational lifetime. Reactants, for example, air containing hydrogen and oxygen, entering a fuel cell may vary in temperature and humidity, and thus may affect the membrane and the performance of a PEM fuel cell.

For a PEM fuel cell to operate efficiently and produce maximum output power, the PEM fuel cell should be properly humidified. By controlling the humidity of inlet air into the cathode, it is possible to affect the water transport through the electrolyte membrane. Specifically, it is possible to balance electro osmotic drag (e.g. water molecules dragged across the electrolyte membrane from the anode to the cathode by the hydrogen protons) and back diffusion (e.g. water molecules moving from the cathode to the anode due to the gradient of water across the electrolyte membrane). Humidifying the cathode inlet air allows PEM fuel cells to operate at higher temperatures and produce greater power output. If PEM fuel cells are less than properly humidified, PEM fuel cells may dry out and result in impeded electrochemical reactions. For example, electrolyte membrane pores may shrink if the membrane becomes dehydrated, which may limit the back diffusion of the water from the cathode to the anode. However, too much water at PEM fuel cells may also cause additional problems. If excessive water is formed at the cathode, kinetics of the reduction reaction at the cathode may be impeded. Therefore, a need exists for an efficient method of air flow to properly humidify a fuel cell.

In consideration of the aforementioned circumstances, the present disclosure provides a method and system for air flow management of fuel cell power systems.

One aspect of the present disclosure is directed to a method of managing air flow for a fuel cell power system, comprising: providing air expelled from a humidification device; providing air expelled from a humidification device; mixing the air expelled from the compressor with the air expelled from the humidification device upstream of a fuel cell; and supplying the air mixture to a cathode of the fuel cell.

Another aspect of the present disclosure is directed to a fuel cell air flow management system, comprising: a compressor configured to supply air to a fuel cell; a humidification device configured to supply air to the fuel cell; and a controller configured to determine an amount of air directed from the compressor to the humidification device and an amount of air that by-passes the humidification device.

Another aspect of the present disclosure is directed to a fuel cell air flow management system, comprising: a compressor; a humidification device; a fuel cell fluidly connected to the compressor and the humidification device; and a controller configured to regulate the air flowing from the compressor to the fuel cell and from the compressor to the humidification device, wherein a first percentage of air flows from the compressor to the fuel cell and a second percentage of air flows from the compressor to the humidification device, and the first percentage is not equal to the second percentage.

It is to be understood that both the foregoing general description and the following detailed description are exemplary and explanatory only and are not restrictive of the disclosure, as claimed.

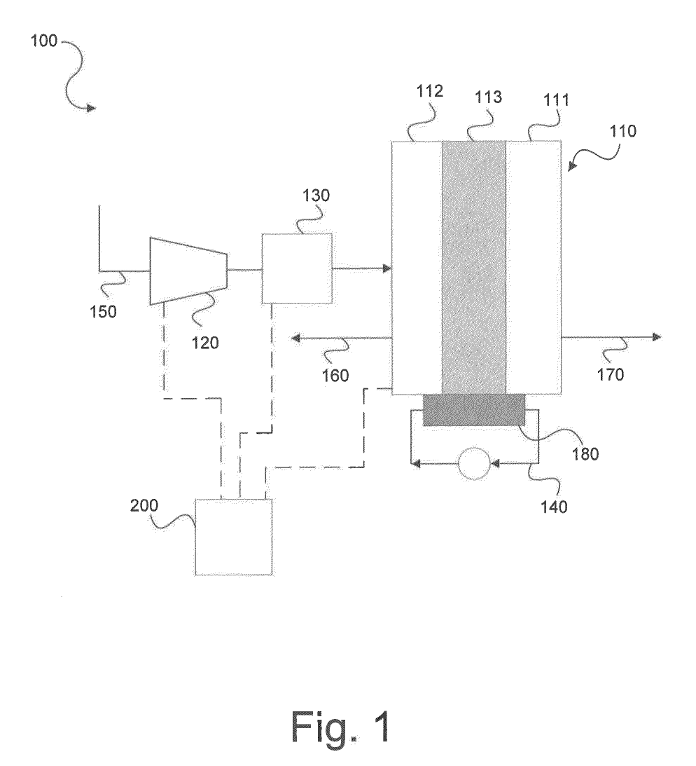

FIG. 1 is a schematic diagram of part of a fuel cell power system, according to an exemplary embodiment.

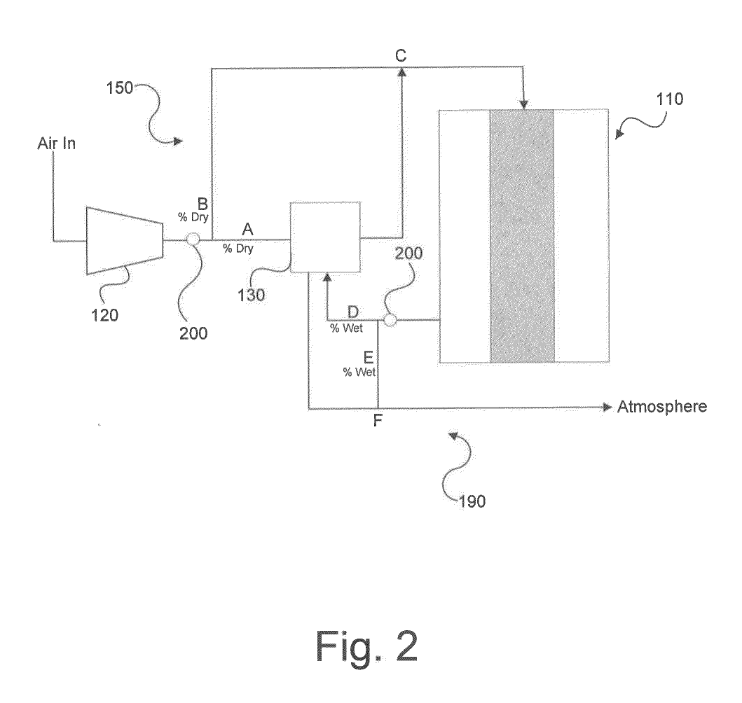

FIG. 2 is a graph illustrating the flow paths of the fuel cell power system, according to an exemplary embodiment.

The present disclosure is described herein with reference to illustrative embodiments for particular applications, such as, for example, an air flow system for automotive PEM fuel cells. It is understood that the embodiments described herein are not limited thereto. Those having ordinary skill in the art and access to the teachings provided herein will recognize additional modifications, applications, embodiments, and substitution of equivalents that all fall within the scope of the present disclosure. For example, the principles described herein may be used with any suitable PEM fuel cell for any suitable application (e.g., automotive, portable, industrial, stationary, backup power or mobile device fuel cell applications). Accordingly, the present disclosure is not limited by the foregoing or following descriptions.

FIG. 1 is a schematic diagram of a power system 100, according to an exemplary embodiment. Power system 100 may include a fuel cell 110, a compressor 120, a humidification device 130, an electric circuit 140, and a controller 200. Fuel cell 110 may further include an anode 111, a cathode 112, and a proton exchange membrane (PEM) 113. Fuel cell 110 may receive a variety of fuels, such as, hydrogen, carbon monoxide, methanol, or dilute light hydrocarbons including methane. Anode 111 may electrochemically split the fuel into electrons and protons. The electrons may flow through electric circuit 150 to cathode 112 and generate electricity in the process, while the protons may move through PEM 113 to cathode 112. At cathode 112, protons may combine with electrons and react with oxygen supplied by air supply 120 to produce water and heat. Excess water produced at cathode 112 may be removed from fuel cell 110 by way of a cathode outlet stream 160. Anode outlet stream 170 may allow unused fuel in anode 111 to exit fuel cell 110. The unused fuel may be recycled to increase overall power system efficiency.

Fuel cell 110 may comprise a PEM fuel cell with an open flow field design. Open flow field fuel cells are described in commonly assigned U.S. Patent Appln. Pub. No. 2011/0223514, which is herein incorporated by reference in its entirety. The open flow field design may allow the water produced at cathode 112 to flow back and humidify PEM 113.

In some embodiments, fuel cell 110 may be stacked (not shown) with a plurality of fuel cells to form a fuel cell stack. For example, if fuel cell 10 is unable to generate enough electrical power to support a given application on its own, it may be stacked to provide a sufficient amount of power.

Inlet stream 150 may supply air to cathode 112 of fuel cell 110. As shown in FIG. 1, inlet stream 150 may pass through compressor 120 and humidification device 130 en route to cathode 112. The air supplied by inlet stream 150 may vary according to one or more factors, for example, availability, temperature, pressure, or humidity. For example, the air may include ambient air from an environment about fuel cell 110. Ambient air may have between 0-100 percent relative humidity, as measured at the temperature of the ambient air.

Compressor 120 may be configured to compress the air within inlet stream 150 before the air enters fuel cell 100. Air may be drawn into compressor 120 through a suction inlet (not shown) and discharged from compressor through an outlet (not shown). In one embodiment, compressor 120 may compress the air within an internal chamber (not shown) and produce dry air. As discussed in more detail below with regard to FIG. 2, the dry air may flow to humidification device 130 or fuel stack 110. Compressor 120 may include any type of compressor as is known in the art, including a piston, screw, scroll, or pancake type.

Dry air from compressor 120 may flow to humidification device 130 via inlet stream 150. Therefore, humidification device 130 may be fluidly connected to cathode 112 between compressor 120 and fuel cell 110. Humidification device 130 may be configured to alter the humidity of inlet stream 150 by heating, cooling, or adding water to air within inlet stream 150. For example, humidification device 130 may add sufficient water to increase the humidity by, for example about +/−1%, about +/−2%, about +/−5%, or about +/−10%. Humidification device 130 may be powered by electric circuit 140 or another alternative power source.

In alternative embodiments (not shown), humidification device 130 may be integrated into fuel cell 110 or a fuel cell stack, thus forming a single device. Such an integrated humidification device may comprise additional plates assembled into the fuel cell or fuel cell stack. The additional plates may separate the stack into fuel cell zones and humidification zones. The humidification zones may include a hydrophilic membrane that may allow coolant water to permeate through the membrane and humidify the gas in the adjacent zone. The integrated humidification device may reduce the space requirements and the amount of interconnecting hardware.

As described above, several reactions may occur within fuel cell 110. Protons and electrons may combine at cathode 112, and may react with oxygen to produce water and heat. The heat produced may be removed from fuel cell 110 by a variety of mechanisms. For example, the fuel cell may include coolant channels, which allow a flow of coolant fluid to remove the heat from the fuel cell and expel the heat externally. In addition a heat exchanger 180 may be used to expel the excess heat generated. Heat exchanger 180 may comprise, for example, a shell and tube, plate, plate and shell, or plate and fin heat exchanger. Heat exchanger 180 may be adjacent to fuel cell 110, allowing the heat generated to travel to heat exchanger by means of conduction. An alternative arrangement may include having a coolant fluid flow through fuel cell 110 and carry the excess heat to heat exchanger 180 where it can be expelled.

Controller 200 may be connected to compressor 120, humidification device 130, fuel cell, and various sensors (not shown) to monitor and regulate power system 100. Controller 200 may be configured to detect one or more parameters of power system 100 and regulate the air flow based on these parameters. For example, controller 200 may be configured to determine the amount of air flowing into humidification device 130 and fuel cell 110 based on the parameters. In one embodiment, controller 200 may be an integrated component of power system 100. In other embodiments, controller 200 may be a separate component in communication with the various components of power system 100.

As shown in FIG. 2, inlet stream 150 may include a plurality of passages fluidly connecting compressor 120, humidification device 130 and fuel cell 110. Additionally, an outlet stream 190 may include a plurality of passages fluidly connecting fuel cell 110 and humidification device 130. For example, a first percentage of air from compressor 120 may flow to humidification device 130 (point A), via inlet stream 150. A second percentage of air from compressor 120 may by-pass humidification device 130 and flow directly to fuel cell 110 (point B), via inlet stream 150. The first and second percentages may be the same or different amounts. In one embodiment, about 100 percent of air flows to humidification device 130 and about 0 percent of air by-passes humidification device 130. In other embodiments, about 75 percent of air may flow to humidification device 130 and about 25 percent of air may by-pass humidification device 130. In yet other embodiments, about 50 percent of air may flow to humidification device 130 and about 50 percent of air may by-pass humidification device 130. In still other embodiments, about 25 percent of air may flow to humidification device 130 and about 75 percent of air may by-pass humidification device 130. In other embodiments, about 0 percent of air may flow to humidification device 130 and about 100 percent of air may by-pass humidification device 130.

For example, the total amount of air may be directed from compressor 120 to humidification device 130. In another example, the amount of air directed from compressor 120 to humidification device 130 may be 3 times more than the amount of air directed from compressor 120 to fuel cell 110 (i.e. the air that by-passes humidification device 130). In another example, the amount of air directed from compressor 120 to humidification device 130 may be equal to the amount of air directed from compressor 120 to fuel cell 110. In yet another example, the amount of air directed from compressor 120 to humidification device 130 may be a third of the amount of air directed from compressor 120 to fuel cell 110. Additionally, the total amount of air may from compressor 120 may be directed to fuel cell 110.

Controller 200 may determine the amount of air that flows to humidification device 130 and the amount that by-passes humidification device 130 based on various factors including, for example, the performance of fuel cell 110, operational conditions, environmental conditions, relative humidity of the air upstream fuel cell 110, dew point temperature of the air upstream fuel cell 110, inlet or outlet coolant temperature of fuel cell 110, etc.

As descried above, compressor 120 may expel dry air, and humidification device 130 may alter the consistency of this air and expel air having increased humidity (e.g. wet air). The wet air from humidification device 130 may mix with the dry air from compressor 120 that by-passed humidification device 130 (point C). As shown in FIG. 2, the mixing may be upstream of fuel cell 110. The mixed dry and wet air may flow into cathode 112 of fuel cell 110.

Outlet stream 190 may fluidly connect fuel cell 110 with humidification device 130, and may fluidly connect fuel cell 110 with the atmosphere. In some embodiments, outlet stream 190 may recirculate air expelled from fuel cell 110 back to humidification device 130. This recirculated air may be wet air, and may mix with dry air from compressor 120 within humidification device 130. As shown in FIG. 2, this mixed air may then flow back to fuel cell 110 via inlet stream 150.

In other embodiments, a first percentage of air from fuel cell 110, for example wet air, may flow to humidification device 130 (point D), via outlet stream 190, and may be recirculated within power system 100. A second percentage of air from fuel cell 110, for example wet air, may be released into the atmosphere (point E), via outlet stream 190. The second percentage of air may mix with wet air expelled from humidification device 130 (point F), before it is released into the atmosphere. The first and second percentages may be the same or different amounts. In one embodiment, about 100 percent of air flows to humidification device 130 and about 0 percent of air flows to the atmosphere. In other embodiments, about 75 percent of air may flow to humidification device 130 and about 25 percent of air may flow to the atmosphere. In yet other embodiments, about 50 percent of air may flow to humidification device 130 and about 50 percentage of air may flow to the atmosphere. In still other embodiments, about 25 percent of air may flow to humidification device 130 and about 75 percent of air may flow to the atmosphere. In other embodiments, about 0 percent of air may flow to humidification device 130 and about 100 percent of air may flow to the atmosphere.

For example, all the amount of air may be directed from fuel cell 110 to humidification device 130. In another example, the amount of air directed from fuel cell 110 and to humidification device 130 may be 3 times more than the amount of air directed from fuel cell 110 and into the atmosphere. In yet another example, the amount of air directed from fuel cell 110 and to humidification device 130 may be equal to the amount of air directed from fuel cell 110 and into the atmosphere. In still another example, the amount of air directed from fuel cell 110 and to humidification device 130 may be a third of the amount of air directed from fuel cell 110 and into the atmosphere. Additionally, the total amount of air from fuel cell 110 may be directed to the atmosphere.

Controller 200 may determine the amount of air that flows to humidification device 130 and the amount that flows to the atmosphere based on various factors including, for example, the performance of fuel cell 110, operational conditions, environmental conditions, relative humidity of the air upstream fuel cell 110, dew point temperature of the air upstream fuel cell 110, inlet or outlet coolant temperature of fuel cell 110, etc.

In some embodiments, the flow rate of the air expelled from humidification device 130 (that is driven to point C) may be less than the flow rate of the air expelled from compressor 120 (that is driven directly to point C and by-passes humidification device 130 at point B). For example, the flow rate of the air expelled from humidification device 130 may be reduced from about 100 to about 0% compared to the air that by-passes humidification device 130. This reduction in flow rate may vary depending on the optimal humidity required of the air entering fuel cell 110. Additionally, the air expelled from humidification device 130 (that is driven to point C) may include a substantially equal pressure to the air expelled from compressor 120 (that is driven directly to point C and by-passes humidification device 130 at point B). One or more valves 200, or other hydraulic devices for example, may be used to regulate the pressure of the air expelled from compressor 120 and humidification device 130.

The separation of the dry and wet air within the passages of inlet stream 150 and outlet stream 190 may create uneven pressure within the passages. For example, the dry air within inlet stream 150 may include a higher pressure than the wet air within outlet stream 190. Therefore, points A, B, and C may each include a higher pressure than points D, E, or F. The passages of inlet stream 150 and outlet stream 190 may include various internal diameters to substantially even or otherwise alter the pressures within the passages. For example, the passages with dry air may include larger diameters than the passages with wet air.

Valves 200 may additionally alter the flow of air within inlet stream 150 and outlet stream 190. For example, valves 200 may direct the air from compressor 120 and into either humidification device 130 or fuel cell 110. Additionally or alternatively, valves 200 may direct the air, for example, from fuel cell 110 and into either humidification device 130 or to the atmosphere. It is contemplated that valves 200 may be disposed at various locations within power system 200 to the direct air. Valves 200 may be proportional or on-off depending on the tuning level required for a specific application.

The air flow of power system 100 may allow humidification device 130 to alter the consistency (e.g. make more humid) of a reduced amount of air from compressor 120. For example, humidification device 130 may circulate a reduced amount of air from compressor 120 at a reduced flow rate. Therefore, humidification device 130 may comprise a smaller size from traditional devices. For example, humidification device 130 may comprise a volume reduced by about 50%, about 40%, about 30% , about 20%, or about 10% and a weight reduced by about 50%, about 40%, about 30% , about 20% , or about 10%. Additionally, power system 100 may provide air flow to a fuel cell of a desired humidity, and increase the life of the fuel cell. Such control of the humidity of a fuel cell, by power system 100, may allow for optimization of a fuel cell stack with regard to voltage and current output.

Other embodiments of the present disclosure will be apparent to those skilled in the art from consideration of the specification and practice of the present disclosure. It is intended that the specification and examples be considered as exemplary only, with a true scope and spirit of the present disclosure being indicated by the following claims.

What is claimed is:

1. A method of managing air flow for a fuel cell power system, comprising:
providing air expelled from a compressor;
providing air expelled from a humidification device;
mixing the air expelled from the compressor with the air expelled from the humidification device upstream of a fuel cell; and
supplying the air mixture to a cathode of the fuel cell.

2. The method of claim 1, further including determining a first percentage of air expelled from the compressor to be directed into the humidification device.

3. The method of claim 2, wherein the determination is based on performance factors chosen from relative humidity of air upstream of the fuel cell, dew point temperature of air upstream of the fuel cell, inlet coolant temperature of the fuel cell, or outlet coolant temperature of the fuel cell.

4. The method of claim 2, further including determining a second percentage of air expelled from the compressor to be directed to by-pass the humidification device.

5. The method of claim 4, wherein the first percentage is about 50% and the second percentage is about 50% of the total air expelled from the compressor.

6. The method of claim 1, wherein the air expelled from the compressor is dry air and the air expelled from the humidification device is wet air.

7. The method of claim 1, wherein the air expelled from the compressor has a higher flow rate than the air expelled from the humidification device.

8. The method of claim 1, further including directing a third percentage of air from the fuel cell to the humidification device and a fourth percentage of air from the fuel cell and into the atmosphere.

9. The method of claim 8, wherein a determination of the amount of air directed from the fuel cell and to the humidification device or to the atmosphere is based on performance factors chosen from relative humidity of air upstream the fuel cell, dew point temperature of air upstream the fuel cell 110, inlet coolant temperature of the fuel cell, or outlet coolant temperature of the fuel cell.

10. The method of claim 8, wherein the third percentage is about 50% and the fourth percentage is about 50% of the total air from the fuel cell.

11. A fuel cell air flow management system, comprising:
a compressor configured to supply air to a fuel cell;
a humidification device configured to supply air to the fuel cell; and
a controller configured to determine an amount of air directed from the compressor to the humidification device and an amount of air that by-passes the humidification device.

12. The fuel cell system of claim 11, wherein the determination is based on performance factors chosen from relative humidity of air upstream of the fuel cell, dew point temperature of air upstream of the fuel cell, inlet coolant temperature of the fuel cell, or outlet coolant temperature of the fuel cell.

13. The fuel cell system of claim 11, wherein the air supplied from the compressor is dry air and the air supplied from the humidification device is wet air.

14. The fuel cell system of claim 11, wherein the air supplied from the compressor has a higher flow rate than air supplied from the humidification device.

15. The fuel cell system of claim 11, wherein humidification device is configured to recirculate air from the fuel cell.

16. The fuel cell system of claim 11, wherein the amount of air directed from the compressor to the humidification device is 3 times more than the amount of air that by-passes the humidification device.

17. The fuel cell system of claim 11, wherein the controller is configured to determine an amount of air directed from the fuel cell and into the humidification device and an amount of air that is directed from the fuel cell and into the atmosphere.

18. The fuel cell system of claim 17, wherein the determination of air from the fuel cell is based on performance factors chosen from relative humidity of air upstream of the fuel cell, dew point temperature of air upstream of the fuel cell, inlet coolant temperature of the fuel cell, or outlet coolant temperature of the fuel cell..

19. The fuel cell system of claim 17, wherein the amount of air directed from the fuel cell to the humidification device is 3 times more than the amount of air that is directed from the fuel cell to the atmosphere.

20. A fuel cell having an air flow management system, comprising:
a compressor;
a humidification device;
a fuel cell fluidly connected to the compressor and the humidification device; and
a controller configured to regulate the air flowing from the compressor to the fuel cell and from the compressor to the humidification device,
wherein a first percentage of air flows from the compressor to the fuel cell and a second percentage of air flows from the compressor to the humidification device, and the first percentage is not equal to the second percentage.
